(19) United States
(12) Patent Application Publication
(10) Pub. No.: US 2006/0055710 A1
(43) Pub. Date: Mar. 16, 2006

(54) Image processing method and device thereof

(76) Inventors: Jui-Lin Lo, Yongkang City (TW); Don-Chen Hsin, Yangmei Township (TW)

Correspondence Address: J C PATENTS, INC., 4 VENTURE, SUITE 250, IRVINE, CA, 92618, US

(21) Appl. No.: 11/015,850

(22) Filed: Dec. 16, 2004

(30) Foreign Application Priority Data
Sep. 16, 2004 (TW) 93127969

(51) Int. Cl. G09G 5/00

(52) U.S. Cl. 345/629

(57) ABSTRACT

An image processing method and device thereof are provided. In the method, at least one input signal is received and a control signal is inputted. Then, at least one region of image signal is selected from the input signals to be processed according to the control signal. Thereafter, an output signal is generated by combining the processed region of the image signal and the other regions of image. Different setting of processing parameters can be applied to different regions of image according to the users' setting. The control signal may comprise a region selection signal and/or a parameter-setting signal. Therefore, at least one of the input signals may be selected according to the selection signal and be adjusted according to the parameter setting signal. Or, an image region of the input signal(s) may be selected according to the area selection signal and be adjusted according to the parameter setting signal.

### CROSS-REFERENCE TO RELATED APPLICATION

This application claims the priority benefit of Taiwan application serial No. 93127969, filed on Sep. 16, 2004.

### BACKGROUND OF THE INVENTION

1. Field of the Invention

The present invention relates to an image processing method and device thereof. More particularly, the present invention relates to an image processing method and device thereof that permits a user to adjust image frames in a video sequence and the sequence of processing the images within the device.

2. Description of the Related Art

With the rapid development of the display technology of liquid crystal displays (LCD) and plasma displays and liquid crystal projectors (LCP) in recent years, the users demand more functional capabilities in display devices. For example, large size display with high resolution of color and containing more number of pixels are in greater demand. In particular, as the size of the display frame is increased, the number of input signal sources may be more than one. More and more users demand for multiple windows display function or picture-in-picture (PIP), picture-on-picture (POP) function on the same display and function of and different kinds of processing in every window or every input signal source. Therefore, the kind of picture-adjusting functions provided in the display device must be increased correspondingly.

For example, a display device can show a computer graphic image and a movie's image sequence simultaneously. In the past, if the brightness level of the movie is too low and demands some brightness or contrast adjustment to the movie in order to obtain a better visual effect, only the brightness or contrast of the entire frame can be adjusted. As a result, the computer graphic image will be too bright. Therefore, it is preferable that if user can select a window or a region in the display and adjust the brightness levels of different windows or regions to different values without affecting the other part of the image on the display device. It is quite clear that it is quite desirable for the users that a display can offer such flexibility to adjust image parameters to different values according to input source and location of pixels.

FIG. 1 is the block diagram showing the conventional image-processing device for controlling display device. Referring to FIG. 1, a conventional image-processing device 100a for controlling a display device 112 includes an image processor 102 and a buffer 104 (optionally, illustrated with dash lines). The processor 102 can receive a plurality of input signals, for example, the first, the second to the N^{th} input signals, as some examples: from a computer, a DVD player, a television broadcasting signal, a cable television network and any other methods/devices which can provide video signals. The image processor 102 receives the input signals, processes the input signals and combines the processed signals to obtain an output signal. The optional buffer 104 is coupled to the processor 102 for storing data. The combined output signal is transmitted to the display device 112 to show images on the display. Conventionally, the image-processing device 100a does not provide the capability to adjust the image parameters to different values in different regions of the image. Therefore, the adjustment of the parameters such as the brightness level and the contrast will affect the entire frame of image.

In some other image-processing device, a post-processor may be connected to the image processor 102 and the optional buffer 104. The post-processor receives the output from previous image processor 102 for further adjusting of input signals.

In the aforementioned conventional image-processing devices, different scaling ratios may be adopted for every input signals respectively because the input signals have to match the display device size or the pixel aspect ratio. In the conventional method, the distortion of the images is magnified since the processed image data has to be processed in the post-processor again. In fact, any kind of additional processing will induce more degradation in image quality. Besides, the coordinates of the image processed by the post-processor are not the same as the coordinates of the original image due to scaling and combining of images. Hence, complicated circuits and algorithms have to be adopted for determining the area and location of a particular point in the displayed image of the display device 112.

In brief, the conventional image-processing device and processing method thereof requires a longer processing time more devices and much larger PCB or chip layout areas. Moreover, the distortion of the image signals is also increased because of additional processing of image. Finally, the display will be high-cost, larger in size and complex to offer the mentioned flexibility. Thus, an efficient, low-cost and flexible image-processing device and operating method thereof is necessary.

### SUMMARY OF INVENTION

The present invention is directed to an image processing method for simplifying image processing sequence, saving image process time, reducing processing steps, circuit layout area, cost, and simplifying the procedure for a user to adjust the image.

The present invention is also directed to an image processing device for simplifying image processing sequence, saving image process time, reducing processing steps, saving circuit layout area, cost, and simplifying the procedure for a user to adjust the image.

According to one embodiment of the present invention, an image processing method including the following steps is provided. First, an input signal and a control signal are received, then at least one region of the input image signal is selected according to the control signal, and thereafter the region selected is processed according to the control signal. Then, the region processed is combined with another portion of the input image signal to form an output signal. The output signal is used for displaying the region processed and another portion of the input image signal. Of course, the selecting and processing steps can be repeated several times to define more different regions and processing methods in each region.

In one embodiment of the present invention, the control signal comprises at least one input selected signals and/or a parameter-setting signal. Users can select at least one of the input signals among all the input signals according to the input selected signal and adjust the selected input signal(s) according to the parameter-setting signal. Alternatively, one can select at least one image region from the input image signal according to the input selected signal and adjust the selected image region according to the adjusting value or parameter corresponding to the parameter-setting signal.

In one embodiment of the present invention, the image processing method may further comprises transmitting the output signal to a display device or to a later stage circuit for additional processing, or storing the output signal in a memory or a storage device.

In one embodiment of the present invention, the input image signal includes a plurality of image signals from different devices. Alternatively, the input image signal includes a single signal having a plurality of windows or a single image from the same device.

In one embodiment of the present invention, the processing operation performed on the selected region may comprise the step of adjusting the gain, the offset, the hue and saturation, the gamma value, the window position or scaling ratio or deploying an over-drive method to improve the response time of the display.

The present invention also provides an image processing device comprising a processor and an input device. The processor includes at least one set of image input terminals for receiving an input image signal. The input device is coupled to the processor. The input device generates and provides a control signal to the processor. Deriving from the control signals, the processor selects at least one region from the input image signal and processing the selected region according to the control signal. The processed region is combined with another portion of the input image signal to form an output signal. The output signal is used for displaying the processed region and the other portions of the input image signal concurrently.

In one embodiment of the present invention, the image processing device transmits the output signal to a display device. The display device comprises, for example, a liquid crystal display, a liquid crystal television, a liquid crystal projector, a plasma display, a cathode ray tube or an organic light-emitting diode display.

In one embodiment of the present invention, the image input device comprises, for example, an analog television receiver, a digital television receiver, a video tape recorder/player, a VCD/DVD player, a computer image card, a digital set-up box, a TV decoder, a digital camcorder or a digital camera.

In one embodiment of the present invention, the input device further comprises, for example, a keyboard, at least one button on the display, a touch panel display, a mouse, a tracker ball, a light pen or a remote controller, or an signals from a chip.

In one embodiment of the present invention, the image processing device further comprises a buffer device connected to the processor for storing an image data of the input image signal and/or the intermediate data.

In one embodiment of the present invention, the processing operations may comprise the step of adjusting the gain, the offset, the hue/saturation and the gamma value of an image or using an over-drive method to improve the response time of the display.

Accordingly, the present invention utilizes the control signals to process the input signals and then combines the input signals to form a processed output signal. In this way, the image processing steps are simplified, the process time is saved and the circuit layout and the cost are reduced. In addition, there is no need to select an image area from the screen when the region to be adjusted by the user is the entire input signal since the specific signal may be directly selected on signal-by-signal basis. Therefore, the procedure for a user to input control signal is substantially simplified.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a conventional image-processing device which provide limited flexibility in parameter adjustment. Although, some mentioned functions can be achieved by an additional post-processor, yet the cost will be higher and also with some other disadvantages.

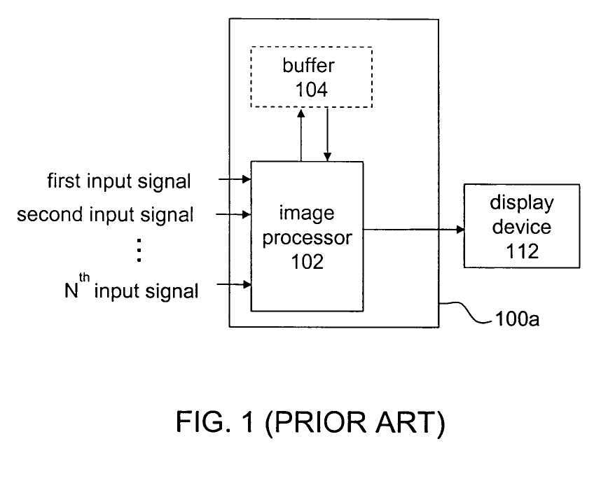

FIG. 2 is a block diagram showing an image-processing device according to one embodiment of the present invention that can provide flexibility yet still meet the low-cost requirement and other advantages.

FIG. 3A shows a multi-window display where a user may adjust different parameters to different values in each window to obtain better viewing quality.

FIG. 3B shows a single window display where a user may like to define several regions and adjust different parameters to different values in each region to obtain better viewing quality.

FIGS. 4A and 4B show an image-processing circuit in the present invention to adjust the gain and offset according to user's setting.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

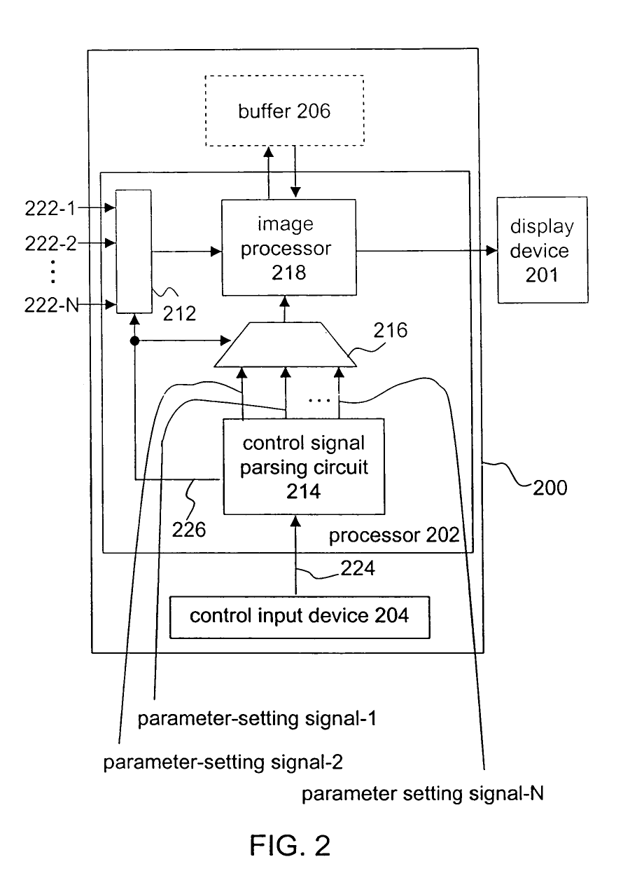

FIG. 2 is a schematic block diagram showing an image-processing device according to one embodiment of the present invention. As shown in FIG. 2, the image-processing device 200 of the present invention comprises a processor 202 and a control input device 204. In another embodiment of the present invention, the image-processing device 200 may comprise an optional buffer 206. The processor 202 comprises, for example, an image-capturing and selecting circuit 212, a control signal parsing circuit 214, an adjust-parameter selection device 216 and an image processor 218. The image-capturing and selecting device 212 comprises at least one set of image input terminals (a plurality of image input terminals are shown in FIG. 2) for receiving an input image signal comprising, for example, the first input signal 222-1 to the N^{th} input signal 222-N. The input signals 222-1 to 222-N of the input image signal may be provided from different input devices such as a computer graphic card, a transition minimized differential signaling (TMDS) terminal, a high definition multimedia interface (HDMI) terminal, an (audio-video) AV terminal, an S-video terminal, a YpbPr terminal, or a CCIR601/656 terminal in the same or different resolution/timing formats. Alternatively, in another embodiment of the invention, the input image signal may comprise only a single signal having a plurality of windows or a single image from a single device such as the one or more window images of a computer or other image output device. In one embodiment of the present invention, the user is permitted to adjust the positions and size of the windows so that the windows may be overlapped or not.

The control input device 204 may be adopted for generating a control signal 224 to the control signal parsing circuit 214 of the processor 202. The control input device 204 may comprise, a keyboard the buttons of a display, a touch panel display, a mouse, a remote controller, the mouse or a tracker ball. In one embodiment of the present invention, a user can input the control signal 224 via the control input device 204. The control signal 224 is interpreted by the control signal parsing circuit 214 in order to generating the corresponding control signal to the image processor 218.

The image-capturing and selecting circuit 212 receives the input image signal including the input signals 222-1 to 222-N and transfer the multiplexed image to the image processor 218 according to the input selected signal 226 from the control signal parsing processor 214. The control signal parsing circuit 214 derives the values of the parameter-setting signal-1 to parameter-setting signal-N corresponding to the input signals 222-1 to 222-N respectively from the control signal 224. The adjust-parameter selection device 216 also selects the adjusting parameters for processing the selected input signals and transfers the adjusting parameters to the image processor 218. Therefore, the image processor 218 of the processor 202 is able to adjust the multiplexed input signals with the corresponding adjusting parameters according to the control signal 224.

Thereafter, the processed image signals are transmitted to a display device 201. The display device 201 may comprise any type of display devices such as a liquid crystal monitor, a liquid crystal television, a liquid crystal projector, a plasma display, a cathode ray tube (CRT) or an organic light-emitting display (OLED). In another embodiment of the present invention, the processed image signals can also be transferred to or stored in a memory, a storage device, an integrated circuit or some other devices for storage or additional processing operations. Various kind of memories including, for example, a static random access memory (SRAM), a dynamic random access memory (DRAM), a flash memory and so on are suitable for storing the processed image signals depending on the purpose. Similarly, many types of storage devices comprise, for example, a floppy discs, an optical discs, a magnetic discs, a hard discs and so on are suitable for storing the processed image signals.

In one embodiment of the present invention, control signal 224 may comprise, an input selected signal 226 and/or a parameter-setting signal (for example, parameter-setting signal-1 to parameter-setting signal-N). The input selected signal 226 may be adopted for selecting at least one region according to the coordinates inputted or selecting at least one of the input signals 222-1 to 222-N which can be derived from the control signal 224. Thus, there is no need to manually select the coordinates if the selected region from the screen if a user likes to adjust any parameter of a specific entire input signal. Instead, the user can directly select the input signal of the image.

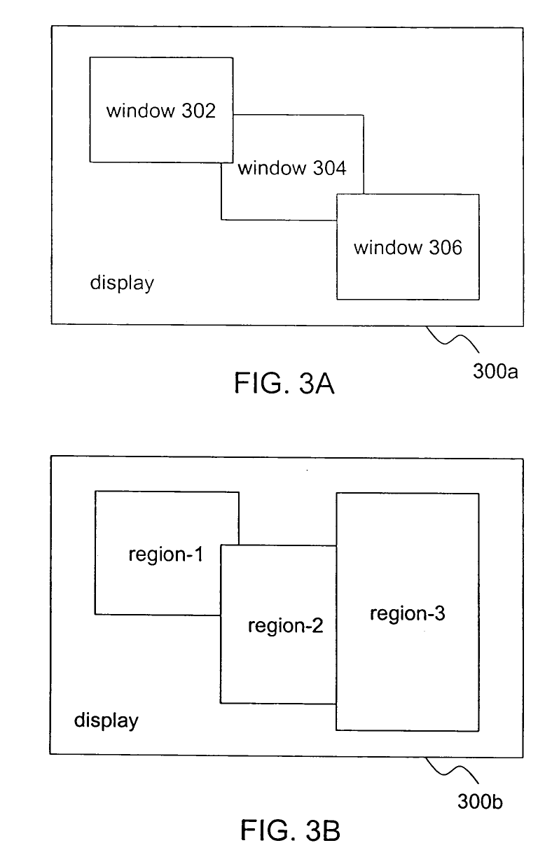

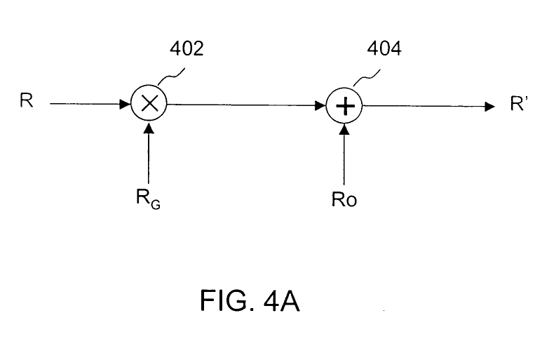

FIG. 3A shows a multi-window display according to one embodiment of the present invention, wherein the display 300a may comprises one or more windows (e.g., the display 300a shown in FIG. 3A comprises three windows 302, 304 and 305. The advantages of the present invention can be readily observed from FIG. 3A. For example, in the conventional input device, user must input the corner coordinates or draw the window 302 by using a such as a button, a keyboard or a mouse, however, it is inconvenient that a user needs to be close to the display device and operate the input device. However, in the present invention, when the windows 302, 304 and 306 are from different input signals respectively, the window 302 may be selected by selecting the input signal directly.

FIG. 3B shows an example of a single window display comprising only a single input signal according to one embodiment of the present invention. As shown in FIG. 3B, the user can set up regions such as region-1, region-2 and region-3 on the display 300b and then set up the parameter-setting signal corresponding to each region.

In one embodiment of the present invention, the parameter-setting value-1 to parameter-setting value-N may comprise, the adjustment parameters of the gain, the offset, the hue/saturation and the gamma value of an image or using an over-drive method to improve the response time of the display. It should be noted that the control signal 224 of the present invention are not limited to the aforementioned embodiment. Any systems that utilizes an control signal 224 to process at least one of the input signals 222-1 to 222-N and then combine the processed signals to form an output signal is also within the scope of the present invention.

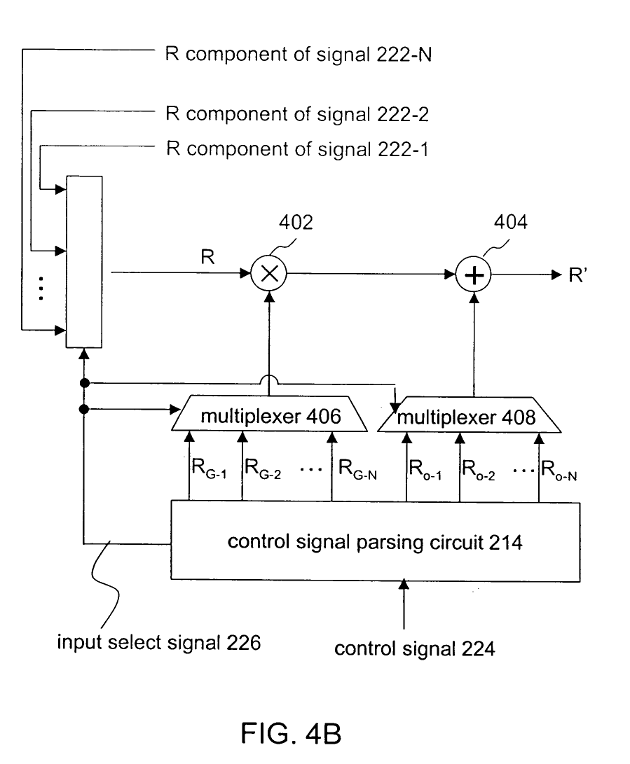

FIGS. 4A and 4B show an image-processing device for processing input signals according to one embodiment of the present invention. As shown in FIG. 4A, the gain and offset of the input signals 222-1 to 222-N can be adjusted by using the following formulae (1), (2) and (3), for example:
R′=R_{G}*R+Ro (1);
G′=G_{G}*G+Go (2);
B′=B_{G}*B+Bo (3).

Here, R, G and B represent the original red (R), the green (G) and the blue (B) components of the input signal before performing any processing operations, and R′, G′ and B′ represent the red (R′), the green (G′) and the blue (B′) components of the processed signal. R_{G}, G_{G} and B_{G} are adjusting parameters representing the gain values of the red, the green and the blue components of the colors. Ro, Go and Bo are adjusting parameters representing the offset value of the red, green and blue components of the colors. FIG. 4A shows the devices related to formula (1). When original signal R is fed into the multiplier 402, the signal R and the signal R_{G} are multiplied together to produce R_{G}*R. When the resulting signal is passed to the adder 404, the signal Ro is added to R_{G}*R to produce R′=R_{G}*R+Ro. A similar method is used to process the green (G) and the blue (B) components of a pixel.

FIG. 4B is a diagram illustrating signal processing units within an image-processing device according to one embodiment of the present invention. In FIG. 4B, the relationship between the input signals 222-1 to 222-N and the control signal 224 is shown, wherein the processing device further comprises multiplexer 406 and 408 except the multiplier 402 and the adder 404. In the following, the red component R of the input signals 222-1 to 222-N is used to illustrate the processing of the red component of the input signals so that R′ represents the red component of the signal after gain/offset processing the red component of the input signal. In general, the control signal 224 may comprise an input selected signal 226 and a parameter-setting signal (for example, parameter-setting signal-1 to parameter-setting signal-N). The input selected signal 226 may comprise a command for selecting at least one input signal or a command for selecting a region according to input coordinate. The parameter-setting signal may comprise, for example, parameter-setting signal-1 to parameter-setting signal-N or the adjusting parameters such as the gain and offset of selected picture regions (e.g., region-1, region-2 to region-N) as R_{G-1}, R_{G-2} to R_{G-N} and R_{O-1}, R_{O-2} to R_{O-N} shown in FIG. 4B. Therefore, as shown in FIG. 4B, when a particular image pixel on the screen is processed, the processor will determine its region of the image pixel according to the coordinates of the image pixel so that the input selected signal 226 required by the multiplexers 406 and 408 is produced. Consequently, the corresponding gain and offset value are sent to the adder 402 and the multiplier 404 for processing the image pixel. Similar methods may be adopted for processing the green (G) and the blue (B) components of the signal.

In one embodiment of the present invention, more generally, the gain and the offset of the input signals 222-1 to 222-N can also be adjusted using the following matrix formula (4):

$$[ \begin{matrix}\begin{matrix}{R}^{′} \\ {G}^{′}\end{matrix} \\ {B}^{′}\end{matrix} ] = [ \begin{matrix}a11 & a12 & a13 \\ a21 & a22 & a23 \\ a31 & a32 & a33\end{matrix} ] [ \begin{matrix}\begin{matrix}R \\ G\end{matrix} \\ B\end{matrix} ] + [ \begin{matrix}\begin{matrix}Ro \\ Go\end{matrix} \\ Bo\end{matrix} ] \qquad ( 4 )$$

Wherein R, G, B and R′, G′, B′ represent the red, green and blue portion of the signal before and after the input signal is processed, the matrix comprising the elements a11, a12, a13 . . . to a33 represent the adjusting parameters for the gain, and Ro, Go, Bo represent the adjusting parameters for the offset. It can also to be used as the sRGB adjustment.

In one embodiment of the present invention, the hue and saturation of the input signals 222-1 to 222-N can be adjusted by fist converting the red, green and blue input signals R, G, B into pre-processed signals in YUV color space. Thereafter, the pre-processed hue signals Y, U, V are converted into post-processed hue signals Y′, U′, V′ using the following matrix formula (5). Finally, the post-processed hue signals Y′, U′, V′ are converted back to the signals R′, G′, B′ before sending to the output device 201.

$$[ \begin{matrix}\begin{matrix}{Y}^{′} \\ {U}^{′}\end{matrix} \\ {V}^{′}\end{matrix} ] = [ \begin{matrix}\begin{matrix}Y * Yg + Yo \\ U cos θ - V sin θ\end{matrix} \\ U sin θ + V cos θ\end{matrix} ] \qquad ( 5 )$$

In one embodiment of the present invention, the gamma value of the input signals 222-1 to 222-N can be adjusted through a look-up table so that the pre-processed red, green and blue input signals R, G and B are converted into post-processed signals R′, G′ and B′. Alternatively, the gamma value can be adjusted using formula (6) to (8):
R′=R^{γ} (6);
G′=G^{γ} (7);
B′=B^{γ} (8),

Wherein γ represents the gamma value parameter. Aside from the aforementioned formulae (6) to (8), the adjustment of the gamma values in a display system can also be achieved by referring to a look-up table.

In one embodiment of the present invention, the input signals 222-1 to 222-N can be adjusted through over-driving method described in the following. For example, when the output device 201 in FIG. 2 is a liquid crystal display, the twisting the liquid crystal molecules inside the display device requires a certain period of time. At the present technical level, the responding speed of the liquid crystal cells is often not fast enough to meet the display quality requirement. To solve this problem, the over-driving method can be applied to provide emphasized driving voltage amplitude applied to driving the liquid crystal cells when displaying a motion frame greater than a driving voltage for displaying a static image. In the present invention, a user may select an area and input the parameters required for adjusting the selected regions in the over-driving mode via the control signal 224.

In one embodiment of the present invention, if the image-adjusting operation is based on the input signal sources instead of regions on the display a simpler method can be used by selecting the entire signal instead of defining a image region.

In one embodiment of the present invention, an image processing method suitable for any display device is provided. The method includes receiving an input image signal and inputting a control signal thereafter. According to the control signal, at least one region is selected from the input image signal to carry out a related processing operation. The processed signal of the selected is combined with the other part of input image signal to form an output signal. The output signal is used for displaying the processed region with the other part of the input image signal concurrently. Afterwards, the output signal is also transmitted to a display device or stored in a memory or storage device. The method can be applied to an image-processing device or combined with a software/hardware image-processing system.

In one embodiment of the present invention, the control signal comprises at least one input selected signal and/or a parameter-setting signal. Therefore, at least one of the input signals may be selected from the input image signal according to the input selected signal, and the selected input signal(s) is adjusted according to the parameter-setting signal. Alternatively, at least one image region may be selected from the input image signal according to the input selected signal, and the image region is adjusted according to the parameter-setting signal.

In one embodiment of the present invention, the input image signal may comprise a plurality of image signals from different devices. Alternatively, the input image signal may comprise a single signal having a plurality of windows or a single image from the same device.

In one embodiment of the present invention, the processing operations performed on the region may comprise a step of adjusting the gain and/or the offset, the hue/saturation, the gamma value, the window position and scaling ratio or deploying an over-drive method to improve the reduce the response time of the display.

In summary, the processor of the present invention may be adopted for determining the region of each pixel, and then the pixel can be adjusted according to the corresponding parameter-setting signal in the region. Therefore, the input signals are processed and then combined to form an output signal. In this way, the image processing steps are simplified, the process time is reduced and the circuit layout and the cost are also reduced. In addition, there is no need to select an image area from the screen when the images region adjusted by the user are belong to one entire input signal since the whole input signal can be directly selected. Hence, the procedure for a user to input a control signal is simplified.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An image-processing method, comprising:
receiving at least an input image signal;
inputting a control signal;
selecting at least one region from the input image signal according to the control signal;
processing the at least one region according to the control signal; and
combining the region processed with another portion of the input image signal to form an output signal;
wherein the output signal serves to display the portion of the region proceeded and the another portion of the input image signal.

2. The image-processing method of claim 1, wherein the control signal comprises at least one input selected signal and/or a parameter-setting signal.

3. The image-processing method of claim 2, wherein the step of selecting the region from the input image and processing the region comprises:
selecting at least one of the input signal among the input image signal according to the input selected signal and adjusting the input selected signal according to the parameter-setting signal.

4. The image-processing method of claim 2, wherein the step of selecting the region from the input image and processing the region comprises:
selecting at least one image region from the input image signal according to the input selected signal and adjusting the image region selected according to at least a parameter corresponding to the parameter-setting signal.

5. The image-processing method of claim 1, wherein the output signal is transmitted to a display device.

6. The image-processing method of claim 1, wherein the output signal is transmitted to a later stage circuit for performing additional processing.

7. The image-processing method of claim 1, wherein the output signal is output to a memory or storage device.

8. The image-processing method of claim 1, wherein the input image signal comprises a plurality of image signals from a plurality of devices.

9. The image-processing method of claim 1, wherein the input image signal comprises a single signal having a plurality of windows or a single image from a device.

10. The image-processing method of claim 1, wherein the step of processing the region comprises:
adjusting a gain value and/or an offset value of the selected region.

11. The image-processing method of claim 1, wherein the step of processing the region comprises:
adjusting a hue/saturation and/or a brightness level of the selected region.

12. The image-processing method of claim 1, wherein the step processing the region comprises:
adjusting a gamma value of the selected region.

13. The image-processing method of claim 1, wherein the step of processing the selected region comprises:
adjusting a position and/or a scaling ratio of the selected region.

14. The image-processing method of claim 1, wherein the step of processing the selected region comprises:
adjusting the selected region by using an over-driving method.

15. The image-processing method of claim 1, wherein the step of processing the region selected comprises:
adjusting the selected region by using a look-up table.

16. An image-processing device, comprising:
a processor comprising at least one set of image input terminals for receiving an input image signal; and
an input device connected to the processor for generating a control signal and transmitting the control signal to the processor;
wherein the processor selects at least one region of the image signal from the input image signal and processes the selected region, and combines the region processed with another portion of the input image signal to form an output signal.

17. The image-processing device of claim 16, wherein the control signal comprises at least one input selected signal and/or a parameter-setting signal.

18. The image-processing device of claim 17, wherein the processor selects at least one of the input signal from the input image signal to form the region selected according to the input selected signal and adjusting the input signal selected according to the parameter-setting signal.

19. The image-processing device of claim 16, wherein the processor selects at least one image region from the input image signal to form the selected region according to the input selected signal and adjusting the image selected region according to at least a parameter corresponding to the parameter-setting signal.

20. The image-processing device of claim 16, wherein the output signal is transmitted to a display device.

21. The image-processing device of claim 20, wherein the display device comprises a liquid crystal display, a liquid crystal television, a liquid crystal projector, a plasma display, a cathode ray tube or an organic light-emitting diode display.

22. The image-processing device of claim 16, wherein the image-processing device further comprises a later stage circuit for further processing the output signal.

23. The image-processing device of claim 16, wherein the image-processing device comprises a memory device or a storage device for storing the output signal.

24. The image-processing device of claim 16, wherein the input image signal comprises a plurality of signals from a plurality of devices.

25. The image-processing device of claim 16, wherein the input signal comprises a single signal having a plurality of windows or a single image from a device.

26. The image-processing device of claim 16, wherein the input device comprises a keyboard, at least one button of a display, a touch-panel display, a mouse, a tracker ball, a light pen or a remote controller or an output from a chip.

27. The image-processing device of claim 16, wherein the image-processing device further comprises:
a buffer device connected to the processor for storing an image data.

28. The image-processing device of claim 16, wherein the control signal comprises a value for adjusting the gain and/or the offset of the selected region.

29. The image-processing device of claim 16, wherein the control signal comprises a value for adjusting a hue/saturation and/or a brightness level of the selected region.

30. The image-processing device of claim 16, wherein the control signal comprises a value for adjusting a gamma value of the selected region.

31. The image-processing device of claim 16, wherein the control signal comprises a value for adjusting a position and/or a scaling ratio of the selected region.

32. The image-processing device of claim 16, wherein the control signal comprises a value for adjusting a color components of the selected region by using an over-driving method.

33. The image-processing device of claim 16, wherein the image-processing device further comprises:
a look-up table for adjusting the selected region.
